(19) United States
(12) Patent Application Publication
(10) Pub. No.: US 2002/0049356 A1
(43) Pub. Date: Apr. 25, 2002

(54) PROCESS FOR THE PURIFICATION OF POLYETHERS

(76) Inventors: PATHIRAJA A. GUNATILLAKE, MULGRAVE (AU); SIMON JOHN MCCARTHY, FOREST HILL (AU); GORDON FRANCIS MEIJS, MURRUMBEENA (AU)

Correspondence Address: SCHWEGMAN, LUNDBERG, WOESSNER & KLUTH, P.A., P.O. BOX 2938, MINNEAPOLIS, MN, 55402, US

(21) Appl. No.: 09/475,468

(22) Filed: Dec. 30, 1999

Related U.S. Application Data
(63) Continuation of application No. PCT/AU98/00497, filed on Jun. 30, 1997.

(30) Foreign Application Priority Data
Jun. 30, 1997 (AU) PO7616

(51) Int. Cl. C07F 13/00

(52) U.S. Cl. 568/699; 585/833; 568/606

(57) ABSTRACT

A process for the purification of polyethers prepared by acid catalyzed condensation of polyhydroxy compounds includes the steps of: (a) heating the polyether with water for a time and at temperature sufficient to substantially hydrolyze esters formed during polymerization; and (b) separating the polyether from the water. The heating of the polyether and water may be conducted under reflux at a temperature of 60 to 100° C. for a period of 2 to 20 hours. The polyether recovered from step (b) may be subjected to further washing with hot water to remove residual acid.

The present invention relates to a process for the purification of polyethers prepared by acid catalysed condensation of polyhydroxy compounds. The process is particularly suitable for the purification of poly(alkylene oxides).

Poly(alkylene oxides) are important precursors in the production of copolymers and segmented copolymers such as polyurethane and polyurethane urea elastomers. The purity of the poly(alkylene oxide) is of crucial importance in preparing such polymers having high molecular weight and good mechanical properties. Impurities such as acid catalysts interfere with the polymerisation reaction causing undesirable side reactions. Furthermore, incomplete removal of the acid catalyst can cause degradation of the poly(alkylene oxide) as well as the resulting polymers.

Methods for the preparation of poly(alkylene oxides) from dihydroxy compounds such as 1,6-hexanediol are disclosed in DE 1,156,709 and in publications by P. J. Florey and M. J. Rhoad¹ and P. A. Gunatillake et. al.². The procedures described to purify the product in these publications are difficult, especially in commercial scale production. The acid catalyst is usually removed either by repeated crystallisation or by treatment with base such as calcium hydroxide followed by repeated washing of the product with water. Often emulsions are formed during the washing step making the process very time consuming. The addition of salts such as sodium chloride is occasionally required to break emulsions. This further slows down the process as several more washing steps are needed to remove the salt.

U.S. Pat. No. 5,403,912 discloses a process for overcoming some of these problems by using a polymer bound acid catalyst such as Nafion-H (Registered Trade Mark) resin which has the advantage of using filtration to remove the catalyst after polymerisation, thereby simplifying the purification process. However, such catalysts are less effective than mineral acids for polymerisation of certain diols (particularly 1,6-hexanediol) because of competing cyclisation of the monomer.

A requirement accordingly exists for an efficient process to allow economic production of polyethers, in particular poly(alkylene oxides) using mineral acids.

According to one aspect of the present invention there is provided a process for the purification of polyethers prepared by acid catalysed condensation of polyhydroxy compounds which includes the steps of:

(a) heating the polyether with water for a time and at temperature sufficient to substantially hydrolyse esters formed during polymerisation; and

(b) separating the polyether from the water.

The present invention also provides polyethers whenever purified by the process of the present invention.

The polyethers which are suitable for purification by the process include homopolymers and copolymers which are obtained by acid catalysed condensation of two or more polyhydroxy compounds. Suitable polyhydroxy compounds include any polymerisable compound having an availability of at least two hydroxy groups. Such compounds include alkanediols preferably having from 2 to 20 carbon atoms in the main chain. The compounds may be branched or unbranched, cyclic or linear, saturated or unsaturated, substituted or unsubstituted or contain one or more hetero atoms in the main chain. Suitable substituents include any atom, side chain or functional group that does not substantially interfere with the polymerisation process such as substituted or unsubstituted aliphatic or aromatic hydrocarbons, for example, alkyl, alkenyl, alkynyl, aryl or heterocyclyl radicals. Examples of polyhydroxy compounds include 1,6-hexanediol, 1,7-heptanediol, 1,8-octanediol, 1,9-nonanediol, 1,10-decanediol, 1,12-dodecanediol, glycerol, trimethylolpropane, 2-ethyl-2-(hydroxymethyl)-1,3-propanediol, pentaerythritol, 3,3,3,3,5,5,-hexafluoropentanediol, 1,8-octanediol, 3,3,4,4,5,5-hexafluoro-1,5-pentanediol, 2,2,3,3,4,4,5,5-octafluoro-1,6-hexanediol, 2,2,3,3,4,4,5,5,6,6,7,7,8,8,9,9,10,10-hexadecafluoro-1,12-dodecanediol, 1,4-cyclohexanediol and 1,4cyclo-hexanedimethanol.

Polyethers having molecular weights of about 150 to about 10,000 may be conveniently purified by the process of the present invention. Preferred polyethers are poly(alkylene oxides) represented by the formula (I):

H—[O—(CH₂)ₘ—]_{ₙ}—OH (I)

wherein

m is an integer of 1 or more, preferably 4 to 20; and

n is an integer of 2 or more, preferably 2 to 50.

Poly(alkylene oxides) of the formula (I) may include those wherein m is 4 or more such as polytetramethylene oxide (PTMO), polypentamethylene oxide (PPMO), polyhexamethylene oxide (PHMO), polyoctamethylene oxide (POMO) and polydecamethylene oxide (PDMO). The process is particularly useful for purifying poly(alkylene oxides) of the formula (I) wherein m is 6 or more.

The acid-catalysed condensation of polyhydroxy compounds may be carried out by methods described by Gunatillake et. al.². Acid catalysts such as sulphuric and sulphonic acids may be used in the polymerisation. The preferred amount of catalyst used is in the range of about 0.1 to about 10% based on the total weight of the polyhydroxy compound. A preferred level of acid catalyst is about 0.5 to about 2%.

An integral part of the present invention is the discovery of the cause of the emulsion formation during water washing steps for removal of acid catalyst. When acids such as sulphuric acid are used to catalyse the polymerisation of polyhydroxy compounds, a substantial portion of the acid is converted to the ester, alkyl hydrogen sulphate. Esters may also be formed by reaction of sulphuric acid with olefin groups that can form during polymerisation by a side reaction. These esters act as emulsifying agents during the water washing process. This not only causes the washing process to be difficult and time consuming but also makes the acid removal incomplete.

Step (a) is preferably carried out by refluxing at a temperature in the range of about 60 to about 100° C., more preferably about 100° C. The duration of step (a) will depend on the polyether being purified, but is generally in the range of about 2 to about 20 hours. The refluxing hydrolyses a major portion of the esters. Once the esters have been hydrolysed to a level so that the free acid content is over 80%, the emulsion formation is substantially eliminated.

The separation step (b) generally involves allowing the polyether and water to separate into two layers. The polyether may then be separated from the water using any suitable known technique, such as, for example, decantation.

It will be appreciated that additional water washing steps may be carried out after step (b) to remove residual acid. Hot water is preferably used to assist the washing process. After the purification process has occurred, these additional water washings do not cause emulsification.

The process of the present invention enables polyethers of a high purity to be prepared simply and economically. These polyethers are useful per se, for example, as surfactants or reagents in the synthesis of hydrolysis and oxidation resistant polyurethanes. Polyurethanes have various applications and may be used as biomaterials in the manufacture of medical devices, articles or implants such as cardiac pacemakers, catheters, cannulas, implantable prostheses, cardiac assist devices, heart valves, vascular grafts, extra-corporeal devices, artificial organs, pacemaker leads, defibrillator leads, blood pumps, balloon pumps, A-V shunts, biosensors, membranes for cell encapsulation, drug delivery devices, wound dressings, artificial joints, orthopaedic implants and soft tissue replacements.

Polyurethanes also have other non-medical applications. Such applications may include their use in the manufacture of artificial leather, shoe soles; cable sheathing; varnishes and coatings; structural components for pumps, vehicles, etc; mining ore screens and conveyor belts; laminating compounds, for example in glazing; textiles; separation membranes; sealants or as components of adhesives.

The invention will now be described with reference to the following examples. These examples are not to be construed as limiting the invention in any way.

In the examples, reference will be made to the accompanying drawing in which:

FIG. 1 is a graph showing Brookfield viscosity vs. molecular weight of the polyol prepared in Example 2.

### EXAMPLE 1

1,6 Hexanediol (500 g) was placed in a 1L three-necked round bottom flask fitted with a nitrogen inlet and heated to 80° C. to melt the hexanediol. The flask was cooled to 60° C. and concentrated sulphuric acid (5.0 ml) was added dropwise with stirring. The flask was then fitted with a distillation head, magnetic stirrer bar, thermometer and a condenser and heated to 170° C. by placing in an oil bath. The polymerisation was carried out at 170° C. with stirring and nitrogen bubbling for a period of 4.5 h. During this period 105 g of water and cyclic by-product oxepane were collected in the receiving flask.

The polymerised reaction mixture (50 g each) was weighed into five 500 ml round bottom flasks along with 200 ml each of deionised boiling water. Flasks numbered 2 to 5 were fitted with a magnetic stirrer bar and a condenser. These four flasks were placed in oil baths at 110° C. and refluxed for times of 2, 4, 8- and 16 h, respectively. The polyol in the first flask was swirled with boiling water for a few minutes and the poly(hexamethylene oxide) was allowed to solidify. The water was decanted into a beaker, and the solid polymer rinsed three times with fresh 50 ml portions of deionised water and combined with the initial 200 ml. The combined water was then titrated with standardised sodium hydroxide using a phenolphthalein indicator.

The other four flasks were removed from oil baths after the specified reflux times and allowed to cool to room temperature. The water layer was decanted and the solid polymer rinsed with fresh deionised water (three 50 ml portions). All four portions of decanted water were combined and titrated with sodium hydroxide. The amount of acid removed into the water layer in each flask was determined by titration with sodium hydroxide. The results are summarised in Table 1 below.

TABLE 1

| | | Amount of H₂SO₄ removed (wt-% of |
|---|---|---|
| Flask Number | Reflux Time (h) | initially added acid) |
| 1 | 0 | 45 |
| 2 | 2 | 85 |
| 3 | 4 | 89 |
| 4 | 8 | 94 |
| 5 | 16 | 97 |

The polymers obtained after the first reflux in flasks 3 (4 h reflux) and 5 (16 h reflux) were refluxed again with 200 ml of fresh deionised water for 2 h at 110° C., and the amount of acid determined by titration as described above. The amount of acid removed by water in both cases was 0.43% of the originally added acid. The polymers were isolated by decanting off water, and drying at 105° C. under vacuum (0.1 torr) for 15 h. The acid numbers of the dried polymers were determined according to ASTM method D2849. The result indicated that part of the acid may have been removed as the ester during the first water washing. The acid number of the polymers was 0.08 in both cases, which is comparable to the typical acid number values (about 0.10) reported for commercial grade polyols such as poly(tetramethylene oxide).

### EXAMPLE 2

1,6-Hexanediol (50 kg) was placed in a 250 L glass lined reactor which was equipped with a mechanical stirrer, set of condensers and a receiving flask. The reactor temperature was set to 90° C. and the heater to 120° C. while maintaining a blanket of nitrogen over solid hexanediol. Once the hexanediol was melted, the nitrogen was bubbled through the melt at an inlet pressure of 60 kPa while stirring the melt at a flow rate of 175 rpm. Concentrated sulphuric acid (500 ml) diluted with 2 L of deionised water was added to molten hexanediol dropwise over a period of 2 h. After completing the addition, the reactor heater temperature was set to 190° C., nitrogen inlet pressure to 60 kPa and the stirrer speed to 125 rpm. Approximately 1 h later, distillation of water and cyclic by-product commenced. The amount of distillate was monitored by measuring the volume at 1 h intervals, which was continued until a total volume of 10.06 L was collected. At this time a small sample of the reaction mixture was collected from the bottom draw-off valve of the reactor, and the sample analysed by 1H-NMR spectroscopy. The molecular weight of the product as this stage was determined to be 340 using the NMR end group analysis method. The NMR signal areas for signals at 3.65 ppm (CH₂ adjacent to OH end group) and 3.37 ppm (CH₂ adjacent to ether oxygen) were used to calculate the molecular weight. The reaction was continued and samples removed every 1 h for NMR analysis. The average molecular weight of product formed and volume of condensed products measured as a function of reaction time are summarised in Table 2 below. Once 11025 ml of condensed products were collected and a product polymer with a molecular weight of 460 achieved, the reaction was stopped after reacting for additional 50 min. The reactor heater was then turned off and the reaction mixture was allowed to cool down to 120° C. over a period of 30 min.

TABLE 2

| | Volume of water and | Polyol molecular weight |
|---|---|---|
| Reaction Time (h) | oxepane collected (ml) | by NMR spectroscopy |
| 2 | 2475 | — |
| 4 | 5375 | — |
| 6 | 8085 | 230 |
| 8 | 10060 | 340 |
| 9 | 11069 | 420 |
| 9.75 | 11025 | 460 |
| 10.5 | 11445 | 600 |

The reactor heater was set to 120° C. and the stirrer at 125 rpm. Deionised water (200 L) was pumped into the reactor and refluxed for 16 h. During this period the reaction temperature was maintained at 90° C., nitrogen pressure at 60 kPa, and the stirrer speed at 125 rpm. After 16 h, the stirrer and the nitrogen flow were stopped and the reaction mixture allowed to separate. The bottom aqueous layer was drained off and 100 L of hot deionised water added and stirred for 5 min. After draining the bottom water layer, 200 L of fresh deionised water was added and refluxed at 85° C. for 4 h with stirring. The polyol was allowed to separate and the water layer drained off and washed with two more 100 L portions of hot water. The pH of the last two washings remained constant at 6.7. The polyol, after draining off all the water, was dried at 90° C. in the reactor under nitrogen (60 kPa) for 24 h. The dried polyol was filtered using a 2μ filter bag to yield 35 kg of dry polyol. The acid number and the hydroxyl number of the purified polyol were 0.03 and 157.5, respectively.

The progress of the polymerisation reaction can also be monitored by measuring the viscosity of the reaction mixture. The viscosity of samples of the reaction mixture removed at different time intervals was measured using a LVT Brookfield (Registered Trade Mark) viscometer with a number one spindle and guard speed of 60 rpm. Samples of the reaction mixture, placed in 125 ml beaker (42.2 mm ID), was equilibrated to a constant temperature (70° C.) in a water bath for 10 min before taking measurements. The spindle, guard and vessel were wiped clean with lint free tissues and rinsed with ethanol between measurements. The viscosity and the molecular weight determined by NMR end group analysis had a linear relationship as shown in FIG. 1.

### EXAMPLE 3

1,8-Octanediol (200 g) was placed in a 500 ml three-necked round bottom flask fitted with a nitrogen inlet and heated to 80° C. to melt the octanediol. The flask was cooled to 70° C. and concentrated sulphuric acid (2.0 ml, diluted to 10 mL with deionised water) was added dropwise with stirring. The flask was the fitted with a distillation head, magnetic stirrer bar, thermometer and a condenser, and heated to 170° C. by placing in an oil bath. The polymerisation was carried out at 170° C. with stirring and nitrogen bubbling for a period of 4.5 h. Deionised water (200 mL) was added to reaction mixture and refluxed for 15 h. After cooling the flask to solidify the polyol, the water layer was decanted off and the polyol washed three times with 50 ml portions of fresh water. The combined water was then titrated with standardised sodium hydroxide with phenolphathelein indicator. Over 92% of the initial acid was present in the aqueous washings. The washing process was repeated three more times with 200 mL of deionised water, but the refluxing was conducted only for 2 h each time. The resulting poly(octamethylene oxide) was dried at 130° C. for 4 h under vacuum (0.1 torr). The acid number of the dried polymer was 0.10 and the molecular weight 600, as determined by ASTM method D2849 and NMR end group analysis method, respectively.

### EXAMPLE 4

1,6-Hexanediol (160 g) and 1,4-cyclohexanedimethanol (40 g) were placed in a 500 ml three necked round bottom flask fitted with a nitrogen inlet and a magnetic stirrer and heated to 70° C. to melt the mixture. The flask was cooled to 60° C. and concentrated sulphuric acid (2.0 ml diluted to 10 ml with deionised water) was added dropwise with stirring and nitrogen bubbling. The flask was then fitted with a distillation head, magnetic stirrer bar, thermometer and a condensor and heated to 170° C. by placing in an oil bath. The polymerisation was carried out at 170° C. with stirring and nitrogen bubbling for a period of 4.5 h. Deionised water (200 ml) was added to the reaction mixture and refluxed for 15 h. After cooling the flask to solidify the polyol, the water layer was decanted off and the polyol washed three times with 50 ml portions of fresh water. The process was repeated three times by adding 200 ml of fresh water, but with only 2 h refluxing. A final wash of the polyol was carried out by stirring in 1L of boiling deionised water and draining off the water. The polyol was dried at 130° C. for 4 h under vacuum (0.1 torr). The acid number and the hydroxyl number of the purified polyol were 0.09 and 105.5 (molecular weight 1063), respectively.

References

1. P. J. Florey and M. J. Rhoad, Journal of the American Chemical Society, Vol. 72, pp 2216-2219 (1949).

2. P. A. Gunatillake et. al., Polymer International, Vol 27, pp 275-283 (1992).

It will be appreciated that further modifications and alterations may be made to the embodiment described above without departing from the scope or spirit of the present invention.

1. A process for the purification of polyethers prepared by acid catalysed condensation of polyhydroxy compounds which includes the steps of:
(a) heating the polyether with water for a time and at temperature sufficient to substantially hydrolyse esters formed during polymerisation; and
(b) separating the polyether from the water.

2. A process as claimed in claim 1 wherein step (a) is carried out by heating at a temperature in the range of about 60° C. to about 100° C.

3. A process as claimed in claim 1 or claim 2 wherein the duration of step (a) is from about 2 hours to about 20 hours.

4. A process as claimed in any one of claims 1 to 3 wherein the esters are hydrolyzed to a level where the free acid content is over 80%.

5. A process as claimed in any one of claims 1 to 4 wherein the process further includes:
(c) washing the polyether from step (b) with one or more additional water washes.

6. A process as claimed in claim 5 wherein hot water having a temperature of 40-100° C. is used in the one or more additional water washes.

7. A process as claimed in any one of the preceding claims wherein the polyether is selected from homopolymers obtained by acid-catalysed condensation of polyhydroxy compounds and copolymers obtained by acid-catalysed condensation of two or more polyhydroxy compounds.

8. A process as claimed in claim 7 wherein said polyhydroxy compounds include any polymerisable polyhydroxy compound having an availability of two or more hydroxyl groups.

9. A process as claimed in claim 8 wherein the polyhydroxy compounds include alkanediols having from 2 to 20 carbon atoms in the main chain.

10. A process as claimed in claim 7 wherein the polyhydroxy compounds are selected from the group including 1,6-hexanediol, 1,7-heptanediol, 1,8-octanediol, 1,9-nonanediol, 1,10-decanediol, 1,12-dodecanediol, glycerol, trimethylolpropane, 2-ethyl-2-(hydroxymethyl)-1,3-propanediol, pentaerythritol, 3,3,3,3,5,5,-hexafluoropentanediol, 1,8-octanediol, 3,3,4,4,5,5-hexafluoro-1,5-pentanediol, 2,2,3,3,4,4,5,5-octafluoro-1,6-hexanediol, 2,2,3,3,4,4,5,5,6,6,7,7,8,8,9,9,10,10-hexadecafluoro-1,12-dodecanediol, 1,4-cyclohexanediol and 1,4-cyclo-hexanedimethanol.

11. A process as claimed in any one of the preceding claims wherein said polyethers have a molecular weight of from about 150 to about 10,000.

12. A process as claimed in any one of the preceding claims wherein said polyethers comprise poly (alkylene oxides) of formula (I)
H—[O—(CH₂)ₘ—]_{ₙ}—OH (I)
wherein m is an integer of 1 or more and n is an integer of 2 or more.

13. A process as claimed in claim 12 wherein m is from 4 to 20 and n is from 2 to 50.

14. A process as claimed in claim 12 or 13 wherein the poly (alkylene oxide) is selected from the group including polytetramethylene oxide (PTMO), polypentamethylene oxide (PPMO), polyhexamethylene oxide (PHMO), polyoctamethylene oxide (POMO) and polydecamethylene oxide (PDMO).

15. A process as claimed in claim 6 wherein the additional water washes are conducted under reflux or at elevated temperatures.

16. A process as claimed in any one of the preceding claims wherein step (a) is carried out under reflux.
